(19) United States
(12) Patent Application Publication
(10) Pub. No.: US 2023/0326227 A1
(43) Pub. Date: Oct. 12, 2023

(54) ACCESS MANAGEMENT METHOD, APPARATUS, AND SYSTEM USING CLOTHING RECOGNITION

(71) Applicant: ARIA EDGE COMPANY, Seoul (KR)

(72) Inventors: Jung Sik PARK, Suwon-si (KR); Hyung Min KIM, Seoul (KR); Jong Wook KIM, Seoul (KR); Jun Hyuk YOO, Seoul (KR)

(21) Appl. No.: 18/048,857

(22) Filed: Oct. 24, 2022

(30) Foreign Application Priority Data
Apr. 7, 2022 (KR) 10-2022-0043138

(51) Int. Cl. G06V 40/10; G06V 20/52; G07C 9/25

(52) U.S. Cl. CPC G06V 40/103; G06V 20/52; G07C 9/253

(57) ABSTRACT

An access management method includes: acquiring an image of an entrant entering a workplace; determining whether clothing of the entrant satisfies an access clothing requirement for the workplace using the image and a clothing recognition model trained in advance; and providing the entrant with a result of the determination.

### CROSS-REFERENCE TO RELATED APPLICATION(S)

This application claims priority under 35 U.S.C 119(a) to Korean Patent Application No. 10-2022-0043138, filed on Apr. 7, 2022, in the Korean Intellectual Property Office, the disclosure of which is incorporated herein by reference in its entirety.

### BACKGROUND

### 1. Technical Field

The present disclosure relates to an access management method, an access management apparatus, and an access management system for managing access of an entrant, and more specifically, to a method, an apparatus, and a system for managing access using clothing recognition.

### 2. Description of Related Art

A general access control system identifies an entrant and determines whether access is allowable using short-range wireless communication, such as radio frequency identification (RFID) tags and beacons or biometric information.

In recent years, there has been an increasing need for inspecting clothing worn by entrants to expand on a process of checking whether entrants have access authority. In the case of food factories, pharmaceutical factories, or semiconductor factories, etc., foreign substances and or the like may cause a high defect rate of the final products, and in the case of construction sites, unacceptable clothing may increase the risk of accidents, and therefore in recent years, there has been an increasing need for inspecting clothing worn by entrants to expand on a process of checking whether entrants have access authority. In the case of food factories, pharmaceutical factories, or semiconductor factories, etc., foreign substances and or the like may cause a high defect rate of the final products, and in the case of construction sites, the entrant is allowed only while wearing regulated clothing.

However, in the conventional technology, clothing inspection is mainly performed by the Manager's visual inspection or is left to the discretion of an operator, and there is a limitation to accurately inspecting clothing.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to an access management method, an access management apparatus, and an access management system for allowing an entrant who wears clothing appropriate for a workplace to enter the workplace through a clothing inspection.

The following description also relates to an access management method, an access management apparatus, and an access management system for performing highly accurate clothing inspection using artificial intelligence (AI).

In one general aspect, there is provided a method of managing access using recognition of clothing, the method including: acquiring an image of an entrant entering a workplace; determining whether clothing of the entrant satisfies an access clothing requirement for the workplace using the image and a clothing recognition model trained in advance; and providing the entrant with a result of the determination.

In another general aspect, there is provided an apparatus for managing access using recognition of clothing, the apparatus including: a memory; a camera configured to generate an image of an entrant entering a workplace; a display device on which the image is displayed; and a processor electrically connected to the memory, the camera, and the display device, wherein the processor is configured to determine whether clothing of the entrant satisfies an access clothing requirement for the workplace using the image and a clothing recognition model trained in advance.

In another general aspect, there is provided a system for managing access using recognition of clothing, the system including: a first camera configured to generate a first image of an entrant entering a workplace; a second camera configured to generate a second image of the entrant leaving the workplace; a first display device on which the first image is displayed; a second display device on which the second image is displayed; an access management apparatus configured to determine whether clothing of the entrant satisfies an access clothing requirement for the workplace using the first and second images and a pre-trained clothing recognition model; a first door opened when the clothing of the entrant who enters the workplace satisfies the access clothing requirement; and a second door opened when the entrant leaves the workplace.

According to an embodiment of the present disclosure, the clothing of an entrant is inspected using an image of the entrant and an AI-based clothing recognition model, so that the accuracy of a clothing inspection can be increased.

In addition, according to an embodiment of the present disclosure, entrants are managed through clothing inspection of the entrants, so that product defects or accidents due to clothing can be prevented.

In addition, according to an embodiment of the present disclosure, a clothing inspection is performed when an entrant leaves a workplace, so that product defects due to clothing damage occurring during work of the entrant can be detected in advance.

### BRIEF DESCRIPTION OF THE DRAWINGS

FIG. 1 is a view for describing an access management system using clothing recognition according to an embodiment of the present disclosure.

FIG. 2 is a view for describing an access management system using clothing recognition according to another embodiment of the present disclosure.

FIG. 3 is a view for describing an access management apparatus using clothing recognition according to an embodiment of the present disclosure.

FIG. 4 is a view illustrating an image displayed on a display device according to an embodiment of the present disclosure.

FIG. 5 is a view for describing an access management method using clothing recognition according to an embodiment of the present disclosure.

FIG. 6 is a view for describing a method of inspecting clothing according to an embodiment of the present disclosure.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

While embodiments according to the concept of the present invention are susceptible to various modifications and alternative forms, specific embodiments thereof are shown by way of example in the accompanying drawings and will herein be described in detail. However, it should be understood that there is no intent to limit the invention to the particular forms disclosed, rather the invention is to cover all modifications, equivalents, and alternatives falling within the spirit and scope of the invention. In the drawings, like numerals refer to the same or similar functionality throughout the several views.

Hereinafter, embodiments according to the present disclosure will be described in detail with reference to the accompanying drawings.

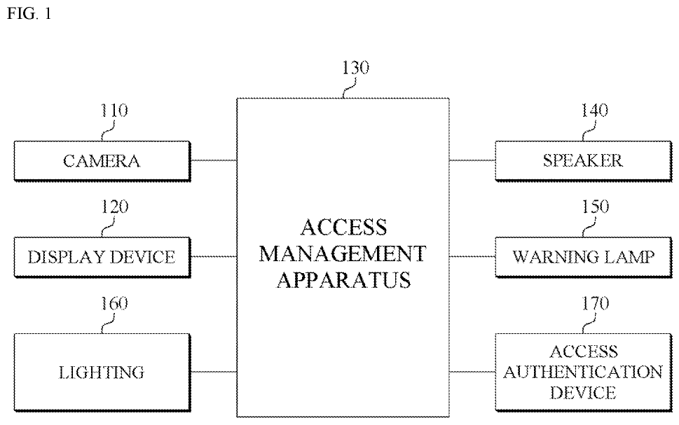

FIG. 1 is a view for describing an access management system using clothing recognition according to an embodiment of the present disclosure.

Referring to FIG. 1, the access management system according to the embodiment of the present disclosure includes a camera 110, a display device 120, and an access management apparatus 130. According to embodiments, the access management system may further include a speaker 140, a warning lamp 150, a lighting 160, an access authentication device 170, and the like.

The camera 110 generates an image of an entrant entering a workplace. The camera 110 may generate an image including the front or rear of the entrant and may generate an image including a specific body part or a whole body of the entrant. The camera 110 may be a closed-circuit television (CCTV) installed at a work site or a separately installed camera.

The display device 120 displays an image generated by the camera 110. A guideline of a body shape may be displayed on the display device 120, and the entrant may stand at a pre-designated position and adjust the position so that the front or rear of the entrant is included in the guideline displayed on the screen, and then an image of the entrant may be generated.

The access management apparatus 130 inspects clothing of the entrant using the image of the entrant and a pre-trained clothing recognition model. Here, the clothing includes not only clothes or accessories worn on the body, but also tools or equipment that may be carried or transported by a human. The clothing recognition model is an artificial intelligence (AI)-based recognition model, and the access management apparatus 130 inspects clothing of the entrant by determining whether the clothing of the entrant satisfies access clothing requirements for the workplace. The access clothing requirements may be set for each workplace or may be set for clothing of each body part. Alternatively, the access clothing requirements may be set for each entrant.

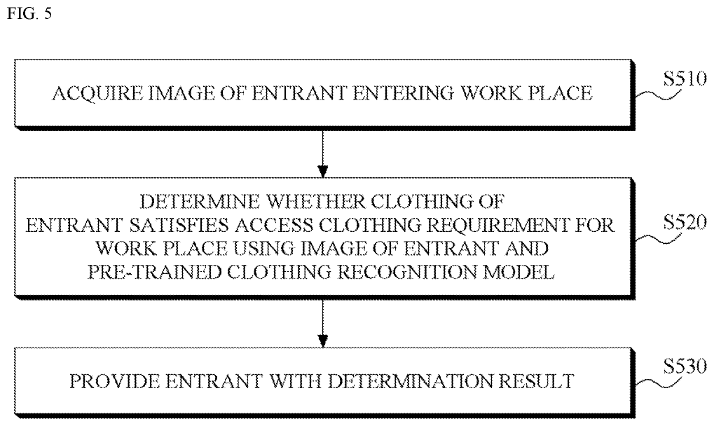

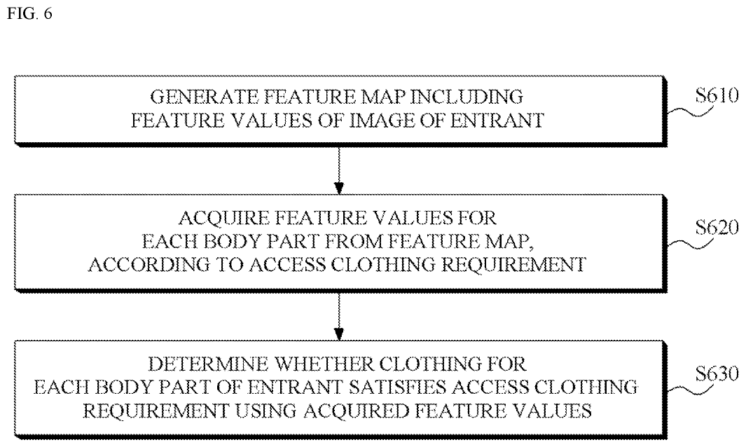

A result of the clothing inspection of the entrant, that is, a result of the determination of whether the access clothing requirement is satisfied, is displayed on the display device 120 and provided to the entrant. The clothing inspection result of the entrant may be displayed in a pass or fail form, and when the access clothing requirements are set for each body part, the clothing inspection results for each body part may be displayed on the display device 120. The clothing inspection result may be provided to the entrant through the speaker 140 and the warning lamp 150 as well as the display device 120. After checking the clothing inspection result, the entrant may correct wrong clothing. A clothing inspection method performed by the access management apparatus 130 will be described in detail below with reference to FIGS. 5 and 6.

The lighting 160 emits light toward the entrant so that an image of the entrant may be acquired in a state in which a constant illuminance is maintained.

The access authentication device 170 checks access authority of the entrant. The access authentication device 170 may check the access authority by a short-range wireless communication method using radio frequency identification (RFID) or a Bluetooth beacon or may check the access authority by a biometric information recognition method, such as voice recognition, face recognition, iris recognition, fingerprint recognition, vein recognition, or the like.

When the clothing inspection result of the entrant whose access authentication is confirmed is that the entrant has passed the clothing inspection, the entrant may enter the workplace.

According to the embodiment of the present disclosure, the clothing of the entrant is inspected using the image of the entrant and the AI-based clothing recognition model, so that the accuracy of the clothing inspection may be increased. In addition, according to the embodiment of the present disclosure, the entrant is managed through the clothing inspection of the inspector, so that defective products or accidents due to clothing may be prevented.

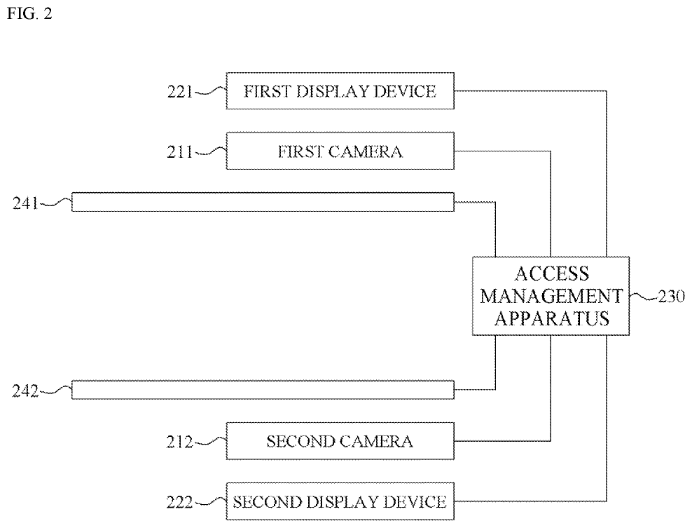

FIG. 2 is a view for describing an access management system using clothing recognition according to another embodiment of the present disclosure.

In the embodiment of FIG. 2, the clothing of an entrant is inspected not only when the entrant enters the workplace but also when the entrant leaves the workplace. The entrant who has passed the clothing inspection when entering may fail the clothing inspection when leaving the workplace, in which case there is a high possibility that the entrant's clothing has been damaged during work, and the damage may cause defects in products produced at the workplace. As the clothing inspection is performed when the entrant leaves the workplace according to the embodiment of FIG. 2, product defects due to damage to the entrant's clothing may be identified in advance.

Referring to FIG. 2, the access management system according to the embodiment of the present disclosure includes first and second cameras 211 and 212, first and second display devices 221 and 222, an access management apparatus 230, and first and second doors 241 and 242.

The first camera 211 generates a first image of an entrant entering the workplace, and the second camera 212 generates a second image of the entrant leaving the workplace.

The first display device 221 displays the first image together with a guideline, and the second display device 222 displays the second image together with a guideline.

The access management apparatus 230 determines whether the clothing of the entrant satisfies access clothing requirements for the workplace using the first and second images and a clothing recognition model trained in advance. The access management apparatus 230 performs a clothing inspection using the first image and the clothing recognition model when the entrant enters the workplace and performs a clothing inspection using the second image and the clothing recognition model when the entrant leaves the workplace. Clothing inspection results are displayed on the first and second display devices 221 and 222, and the access management apparatus 230 controls the operation of the first and second doors 241 and 242 according to the clothing inspection results.

The first and second doors 241 and 242 are spaced a preset interval from each other and disposed to face each other. In addition, the first door 241 is opened when the clothing of the entrant entering the workplace satisfies the access clothing requirements, that is, when the clothing inspection result is that the entrant has passed the clothing inspection. The second door 242 is opened when the entrant leaves the workplace, and according to an embodiment, the second door 242 may be opened when the clothing of the entrant who leaves the workplace satisfies the access clothing requirements, that is, when the clothing inspection result is that the entrant has passed the clothing inspection.

However, the performance of the clothing inspection when the entrant leaves the workplace may be to identify product defects due to damage to the entrant's clothing in advance, rather than to prevent the entrant who fails the clothing inspection from leaving the workplace. In this case, the second door 242 may be opened when the determination of whether the clothing of the entrant who leaves the workplace satisfies the access clothing requirements is completed, regardless of whether the clothing of the entrant who leaves the workplace satisfies the access clothing requirement. In addition, when the clothing of the entrant who leaves the workplace does not satisfy the access clothing requirements, a manager may be notified of the clothing inspection result.

On the other hand, when different entrants enter and leave the workplace at the same time, the first and second doors 241 and 242 may be simultaneously opened when each entrant passes the clothing inspection, or the first and second doors 241 and 242 may be opened alternately rather than simultaneously to prevent another entrant from leaving the workplace without a clothing inspection. That is, the first door 241 may be opened in a state in which the second door 242 is closed, and the second door 242 may be opened in a state in which the first door 241 is closed.

According to the embodiment of the present disclosure, a clothing inspection is performed when the entrant leaves the workplace, so that product defects due to clothing damage occurring during work of the entrant may be detected in advance.

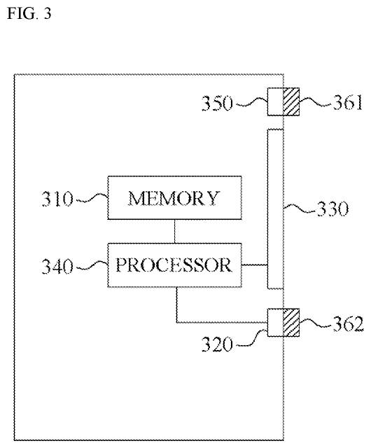

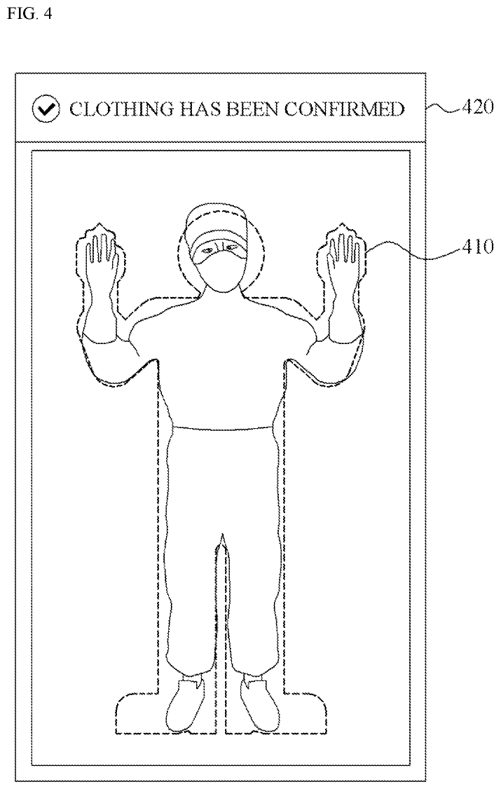

FIG. 3 is a view for describing an access management apparatus using clothing recognition according to an embodiment of the present disclosure, and FIG. 4 is a view illustrating an image displayed on a display device according to an embodiment of the present disclosure.

Referring to FIG. 3, the access management apparatus according to the embodiment of the present disclosure includes a memory 310, a camera 320, a display device 330, and a processor 340, and may be in the form of a kiosk.

The camera 320 generates an image of an entrant entering the workplace, and the image of the entrant is displayed on the display device 330. As shown in FIG. 4, the image of the entrant may be displayed on the display device 330 together with a guideline 410, and a clothing inspection result 420 may also be displayed on the display device 330.

The guideline 410 may have a body shape, for example, a body shape in which both arms are held up, so that clothing such as gloves worn on the hand may be easily identified. When the entrant stands at a predetermined position and takes a pose according to the body shape of the guideline 410, the camera 320 may generate an image of the entrant in which the front or rear of the whole body of the entrant is disposed along the background or the guideline 410.

In this case, the guideline 410 may be adjusted in height according to the height of the entrant standing at the predetermined position. When the height of the entrant is smaller than the guideline 410 having a preset initial height, the height of the guideline 410 is reduced, and when the height of the entrant is larger than the guideline 410 having the initial height, the height of the guideline 410 is increased. The height of the guideline 410 adjusted according to the height of the entrant is updated to the initial height when the clothing inspection is completed. Since the number of entrants entering the workplace is limited, the initial height of the guideline 410 may be determined according to the heights of the entrants entering the working place. As an example, a height corresponding to a height range including the largest number of heights among the heights of the entrants may be set as the initial height, and with such a configuration, the height adjustment operation of the guideline may be minimized.

The processor 340 is electrically connected to the memory 310, the camera 320, and the display device 330, and determines whether the clothing of the entrant satisfies the access clothing requirements for the workplace using the image of the entrant and the pre-trained clothing recognition model.

In addition, the processor 340 may adjust the height of the guideline 410 according to the height of the entrant. The processor 340 may adjust the height of the guideline 410 by measuring the height of the entrant from the image of the entrant photographed by the camera 320 and adjusting a lower body length and an upper body length of the guideline 410 according to the measured height. The processor 340 may detect the face of the entrant from the image of the entrant and estimate the height of the entrant through the length between a pre-designated position and the topmost end of the face.

The access management apparatus according to the embodiment of the present disclosure may further include a lighting 350 in which a first polarizing filter 361 is disposed and which emits light toward the entrant. The first polarizing filter 361 may be disposed in front of the lighting 350 from which light is output, and the light of the lighting is emitted to the entrant after passing through the first polarizing filter 361.

In addition, the camera 320 may include a second polarizing filter 362 that filters out light in the same polarization direction as that of the first polarizing filter 361. The second polarizing filter 362 may be disposed in front of the camera 320 to which reflected light is input, and light reflected from the entrant and objects around the entrant is input to the camera 320 after passing through the second polarizing filter 362.

Among light input to the camera 320 after passing through the second polarizing filter 362, light that has passed through the first polarizing filter 361 has the strongest intensity. Accordingly, an image may be mainly generated from light input to the camera 320 that has passed through the first polarizing filter 361, and the discrimination power of the image of the entrant may be prevented from being lowered by a strong total reflection or backlight due to other nearby light sources

FIG. 5 is a view for describing an access management method using clothing recognition according to an embodiment of the present disclosure.

The access management method according to the embodiment of the present disclosure may be performed in a computing device including a memory and a processor, and as an example, the access management apparatus may be included in the computing device.

The computing device according to the embodiment of the present disclosure acquires an image of an entrant entering a workplace (S510). The image of the entrant may be an image including a background and the front or rear of the whole body of the entrant or may be an image including a preset body part.

The computing device according to the embodiment of the present disclosure determines whether clothing of the entrant satisfies an access clothing requirement for the workplace using the image of the entrant and a clothing recognition model trained in advance (S520).

The clothing recognition model may be generated through various learning models, and as an embodiment, may be a convolutional deep neural network (CNN)-based artificial neural network model. Training data for training the clothing recognition model may include training images of entrants wearing various types of clothing and labels for the training images, and the labels indicate pass and fail for the clothing for each body part of entrants. In addition, the clothing recognition model may be a model trained through different types of training data for each workplace.

The computing device provides the entrant with a result of the determination obtained in operation S520 (S530), and the result of the determination may be provided to the entrant in various forms, such as a display device, a speaker, and a warning lamp.

Meanwhile, as described above, the clothing inspect may also be performed when the entrant leaves the workplace, and the computing device may use an image of the entrant who leaves the workplace and the clothing recognition model to determine whether the clothing of the entrant who leaves the workplace satisfies the access clothing requirements for the workplace.

FIG. 6 is a view for describing a method of inspecting clothing according to an embodiment of the present disclosure.

Referring to FIG. 6, the computing device generates a feature map including feature values of the image of the entrant to determine whether the clothing of the entrant satisfies the access clothing requirements (S610). The feature map may be generated from the CNN-based clothing recognition model described above, and the clothing recognition model may generate a feature map having the same size as that of the image of the entrant.

Then, the computing device acquires feature values for each body part from the feature map according to the access clothing requirements (S620). The access clothing requirements may include clothing requirements for each body part. For example, the access clothing requirements may include clothing requirements for at least one body part among the head, hands, upper body, lower body, and feet, and in response to the access clothing requirements for the head, hands, and feet being set, the computing device may acquire feature values for the head, hands, and feet from the feature map.

As described above, the image of the entrant may be an image in which the front or rear of the entrant's whole body is disposed along the guideline having a body shape displayed on the screen of the display device, and thus the positions of the body parts of the entrant correspond to the positions of the body parts of the guideline. Accordingly, the computing device may acquire feature values for each body part from the feature map using coordinate values of body parts of the guideline.

For example, when the access clothing requirements for the head, hands, and feet are set, the computing device may acquire feature values of the feature map corresponding to the coordinate values of the head, hands, and feet of the guideline.

Depending on the photographing environment, the image of the entrant may be generated in a form in which a part of the entrant's whole-body deviates from the guideline, or another entrant is included in the background area of the image of the entrant. However, according to the embodiment of the present disclosure, coordinate values of the body parts of the guideline are used so that a feature value located inside the guideline among the feature values of the feature map may be acquired. Accordingly, false positives due to noise included in the background area may be prevented from causing errors in the clothing inspection result.

According to embodiments, the computing device may overlap the feature map and a mask having the same shape as that of the guideline and acquire feature values for each body part included in the mask.

The computing device determines whether the clothing for each body part of the entrant satisfies the access clothing requirements using the feature values obtained in operation S620 (S630).

Meanwhile, the above-described access clothing requirements may be set for each entrant as well as for each workplace. That is, even entrants who work in the same workplace may be set to have different access clothing requirements between the entrants according to tasks of the entrants. In such a working environment, the computing device may receive information about entrant-specific access clothing requirements of an entrant whose access authentication for the workplace is completed, and not only determine whether the clothing of the entrant satisfies the access clothing requirements for the workplace, but also determine whether the clothing of the entrant satisfies the entrant-specific access clothing requirements using the information about the entrant-specific access clothing requirements.

The information about the entrant-specific access clothing requirements may be provided from a server that manages access authentication and personal information of entrants, and the server may, when the access authentication is completed for an entrant, transmit the information about the entrant-specific access clothing requirements of the entrant to the computing device.

The technical details described above can be implemented in the form of program commands executable by a variety of computer components and may be recorded on a computer readable medium. The computer readable medium may include, alone or in combination, program commands, data files and data structures. The program commands recorded on the computer readable medium may be components specially designed for the present disclosure or may be usable by a skilled person in the field of computer software. Computer readable record media include magnetic media such as a hard disk, a floppy disk, or a magnetic tape, optical media such as a compact disc read only memory (CD-ROM) or a digital video disc (DVD), magneto-optical media such as floptical disks, and hardware devices such as a ROM, a random-access memory (RAM), or a flash memory specially designed to store and carry out programs. The program commands include not only a machine language code made by a compiler but also a high-level code that can be used by an interpreter etc., which is executed by a computer. The hardware device may be configured to act as one or more software modules in order to perform the operations of the present disclosure, or vice versa.

While the invention has been shown and described with respect to particulars, such as specific components, embodiments, and drawings, the embodiments are used to aid in the understanding of the present invention rather than limiting the present invention, and those skilled in the art should appreciate that various changes and modifications are possible without departing from the spirit and scope of the invention. Therefore, the spirit of the present invention is not defined by the above embodiments but by the appended claims of the present invention, and the scope of the present invention is to cover not only the following claims but also all modifications and equivalents derived from the claims.

What is claimed is:

1. A method of managing access using recognition of clothing, the method comprising:
acquiring an image of an entrant entering a workplace;
determining whether clothing of the entrant satisfies an access clothing requirement for the workplace using the image and a clothing recognition model trained in advance; and
providing the entrant with a result of the determination.

2. The method of claim 1, wherein the acquiring of the image of the entrant includes acquiring the image including a background, and front and rear of a whole body of the entrant.

3. The method of claim 2, wherein the determining of whether the clothing of the entrant satisfies the access clothing requirement includes:
generating a feature map including feature values of the image;
acquiring feature values for each body part from the feature map according to the access clothing requirement; and
determining whether clothing for each body part of the entrant satisfies the access clothing requirement using the acquired feature values.

4. The method of claim 3, wherein the acquiring of the image of the entrant includes acquiring the image in which the front or the rear of the whole body of the entrant is disposed along a guideline of a body shape displayed on a screen of a display device, and
the acquiring of the feature values for each body part includes acquiring the feature values for each body part from the feature map using coordinate values of body parts of the guideline.

5. The method of claim 4, wherein the feature values for each body part are feature values included inside a mask having the same shape as the guideline.

6. The method of claim 4, wherein the guideline is a guideline having a body shape in which both arms are held up, and
the guideline is adjusted in height according to a height of the entrant standing in a predetermined position.

7. The method of claim 1, wherein the determining of whether the clothing of the entrant satisfies the access clothing requirement includes:
receiving information about an entrant-specific access clothing requirement of the entrant whose access authentication to the workplace is completed; and
determining whether the clothing of the entrant satisfies the entrant-specific access clothing requirement using the entrant-specific access clothing requirement information.

8. The method of claim 1, further comprising determining whether clothing of the entrant who leaves the workplace satisfies the access clothing requirement for the workplace using an image of the entrant who leaves the workplace and the clothing recognition model.

9. An apparatus for managing access using recognition of clothing, the apparatus comprising:
a memory;
a camera configured to generate an image of an entrant entering a workplace;
a display device on which the image is displayed; and
a processor electrically connected to the memory, the camera, and the display device,
wherein the processor is configured to determine whether clothing of the entrant satisfies an access clothing requirement for the workplace using the image and a clothing recognition model trained in advance.

10. The apparatus of claim 9, further comprising a lighting in which a first polarizing filter is disposed, and which emits light to the entrant,
wherein the camera includes a second polarizing filter which filters out light in the same polarization direction as the first polarizing filter.

11. The apparatus of claim 9, wherein the display device displays a guideline of a body shape in which both arms are held up and a result of the determination,
the camera generates the image in which front or rear of a whole body of the entrant is disposed along the guideline, and
the guideline is adjusted in height according to a height of the entrant standing in a predetermined position.

12. A system for managing access using recognition of clothing, the system comprising:
a first camera configured to generate a first image of an entrant entering a workplace;
a second camera configured to generate a second image of the entrant leaving the workplace;
a first display device on which the first image is displayed;
a second display device on which the second image is displayed;
an access management apparatus configured to determine whether clothing of the entrant satisfies an access clothing requirement for the workplace using the first and second images and a pre-trained clothing recognition model;
a first door opened when the clothing of the entrant who enters the workplace satisfies the access clothing requirement; and
a second door opened when the entrant leaves the workplace.

13. The system of claim 12, wherein:
the first and second doors are spaced a preset interval from each other and disposed to face each other;
the first door is opened in a state in which the second door is closed; and
the second door is opened in a state in which the first door is closed.

14. The system of claim 12, wherein the second door is opened when the clothing of the entrant who leaves the workplace satisfies the access clothing requirement.

15. The system of claim 12, wherein the second door is opened upon completing the determination of whether the clothing of the entrant who leaves the workplace satisfies the access clothing requirement, regardless of whether the clothing of the entrant who leaves the workplace satisfies the access clothing requirement.
